(19) United States
(12) Patent Application Publication
(10) Pub. No.: US 2025/0100624 A1
(43) Pub. Date: Mar. 27, 2025

(54) SIDE SILL OF VEHICLE WITH REINFORCEMENT MEMBER

(71) Applicants: Hyundai Motor Company, Seoul (KR); Kia Corporation, Seoul (KR)

(72) Inventors: Chang-Un Jeon, Hwaseong-si (KR); Seung-Hyun Kang, Hwaseong-si (KR); Seung-Tae Song, Hwaseong-si (KR); Jang-Won Hong, Hwaseong-si (KR); Yun-Su Jung, Hwaseong-si (KR)

(21) Appl. No.: 18/742,248

(22) Filed: Jun. 13, 2024

(30) Foreign Application Priority Data
Sep. 27, 2023 (KR) 10-2023-0130264

(51) Int. Cl. B62D 25/02

(52) U.S. Cl. CPC B62D 25/025

(57) ABSTRACT

An embodiment side sill of a vehicle includes a side sill outer having a first convex cross section toward an outside of the vehicle, a side sill inner coupled to an inside of the side sill outer and having a second convex cross section toward an inside of the vehicle, and a reinforcement member disposed in a space between the side sill outer and the side sill inner, the reinforcement member including a plurality of thin plates made of a same material as the side sill and joinable to the side sill by welding, the thin plates being joined to each other to define a closed cross section therebetween and disposed in the space.

### CROSS-REFERENCE TO RELATED APPLICATIONS

This application claims the benefit of Korean Patent Application No. 10-2023-0130264, filed on Sep. 27, 2023, which application is hereby incorporated herein by reference in its entirety.

### TECHNICAL FIELD

The present disclosure relates to a side sill of a vehicle with a reinforcement member.

### BACKGROUND

In general, a side sill is installed in a lower portion of a lateral side of a vehicle in a lengthwise direction of the vehicle to form a lateral lower structural body of the vehicle.

Referring to FIG. 1, a side sill 100 is formed by joining upper end portions and lower end portions of a side sill outer 11o, which has a convex cross section toward an outside of the vehicle, and a side sill inner 120, which has a convex cross section toward an inside of the vehicle.

The side sill 100 is connected to side end portions of members constituting a lower portion of the interior compartment of the vehicle, such as a seat cross member 142, a center floor 143, or the like.

A reinforcement member 130 may be applied to an inside of the side sill 100 in order to improve rigidity of the side sill 100. For example, by installing the reinforcement member 130 of an aluminum extruded material between the side sill outer 110 and the side sill inner 120, the rigidity of the side sill 100 may be improved.

However, recently, the spread of electric vehicles has been expanding, and a battery B of the electric vehicle is typically disposed below a floor panel of the vehicle where the battery B is mounted using a mounting bolt 151. To this end, a space of the side sill 100 is reduced, and thus a size of the reinforcement member 130 is reduced.

As described above, since the size of the reinforcement member 130 is reduced, a load supported by the side sill 100 is reduced in the event of a side collision, and thus there is a problem in that the side sill 100 intrudes into the interior compartment of the vehicle by the side collision.

In addition, since the reinforcement member 130 is an extruded member with an aluminum material, which is different from those of the side sill outer 11o and the side sill inner 120 made of a steel material, the reinforcement member 130 may not be joined to the side sill outer 11o and the side sill inner 120 by welding. Accordingly, since an additional bracket is applied to mount the reinforcement member 130 using methods such as bolting and flow drill screw (FDS), etc., there is a problem in that a work process increases.

### SUMMARY

The present disclosure relates to a side sill of a vehicle with a reinforcement member. Particular embodiments relate to a side sill of a vehicle with a reinforcement member that is installed inside the side sill of the vehicle to support a collision load in the event of a side collision and prevents the side sill from intruding into an interior compartment of the vehicle.

An embodiment of the present disclosure provides a side sill of a vehicle with a reinforcement member having the same material as the side sill that may be easily joined to the side sill and may support a collision load inside of the side sill with a limited space to prevent the side sill from intruding into an interior compartment of the vehicle in the event of a side collision.

In accordance with an embodiment of the present disclosure, a side sill of a vehicle with a reinforcement member may include a side sill outer having a convex cross section toward an outside of a vehicle, a side sill inner having a convex cross section toward an inside of the vehicle and coupled to an inside of the side sill outer, and a reinforcement member disposed in a space between the side sill outer and the side sill inner, wherein the reinforcement member may include a plurality of thin plates made of the same material as the side sill to be joined by welding, and wherein the plurality of thin plates is joined to each other to form a closed cross section therebetween and installed in the space.

The plurality of thin plates may include an outer member formed to have a convex cross section toward the outside of the vehicle, an inner member disposed inside the vehicle in the outer member and forming a closed cross section with the outer member, and a center member disposed between the outer member and the inner member and dividing the closed cross section formed by the outer member and the inner member, wherein the outer member, the inner member, and the center member are joined to form the closed cross section in a lengthwise direction of the vehicle.

A plurality of step portions which varies a height of a surface in a lengthwise direction of the vehicle may be formed on surfaces of the outer member, the inner member, and the center member, which are parallel to the ground.

The plurality of step portions may be repeatedly formed on the surfaces at intervals in the lengthwise direction of the vehicle.

The plurality of step portions may be formed to alternately lower or raise heights of the surfaces parallel to the ground.

The outer member may include an upper surface extending to the outside of the vehicle, a vertical surface extending downward from an outer end portion of the upper surface, and a lower surface extending from a lower end portion of the vertical surface to an inside of the vehicle, wherein upper step portions and lower step portions whose heights vary may be repeatedly formed at intervals on the upper surface and the lower surface, respectively, in the lengthwise direction of the vehicle.

The inner member may include a horizontal surface extending inside the vehicle, and step portions whose heights vary may be formed on the horizontal surface.

The center member may include an upper surface extending to the outside of the vehicle, a vertical surface extending downward from an outer end portion of the upper surface, and a lower surface extending from a lower end portion of the vertical surface to the inside of the vehicle and overlapping the lower surface of the outer member to be joined thereto, wherein upper step portions and lower step portions whose heights vary may be repeatedly formed at intervals on the upper surface and the lower surface, respectively, in the length direction of the vehicle.

Upper bonding portions and lower bonding portions may be formed at the upper end portions and the lower end portions of the outer member, the inner member, and the center member, and the upper bonding portions and the lower bonding portions may be joined so that the outer member, the inner member, and the center member may be integrally formed with each other.

The lower bonding portion may be positioned further inside the vehicle than the upper bonding portion.

The upper bonding portion and the lower bonding portion may be joined to a front pillar inner lower of the vehicle within a predetermined length from a front end portion of the reinforcement member.

The upper surface of the center member may be formed within a predetermined length from the front end portion of the reinforcement member.

Beyond a predetermined length from the front end portion of the reinforcement member in the center member, the upper bonding portion of the center member may be directly connected to the vertical surface of the center member.

Beyond a predetermined length from the front end portion of the reinforcement member, the upper bonding portion and the lower bonding portion may be joined to the side sill inner.

In the outer member, the upper bonding portion may be formed to extend upward from an inner end portion of the upper surface, and the lower bonding portion may be formed to extend downward from an inner end portion of the lower surface.

In the inner member, the upper bonding portion may be formed to extend upward from an outer end portion of the horizontal surface, and the lower bonding portion may be formed to extend downward from an inner end portion of the horizontal surface.

In the outer member, the upper bonding portion may be formed to extend upward from an inner end portion of the upper surface, and the lower bonding portion may be formed to extend downward from an inner end portion of the lower surface.

The lower surface of the outer member may be positioned at the same height as a lower end portion of a seat cross member whose side end portion is positioned inside the side sill inner in the vehicle.

The outer member, the inner member, and the center member may be manufactured by a cold stamping process with steel plates.

The outer member may have a thickness greater than that of the inner member, and the inner member may have a thickness greater than that of the center member.

### BRIEF DESCRIPTION OF THE DRAWINGS

FIG. 1 is a cross-sectional view illustrating a side sill according to the related art.

FIG. 2 is a perspective view illustrating a reinforcement member in a side sill of a vehicle with a reinforcement member according to embodiments of the present disclosure.

FIG. 3 is an exploded perspective view illustrating the reinforcement member in the side sill of the vehicle with the reinforcement member according to embodiments of the present disclosure.

FIG. 4 is a front view illustrating a state in which the reinforcement member is disassembled in the side sill of the vehicle with the reinforcement member according to embodiments of the present disclosure.

FIG. 5 is a perspective view illustrating a state in which the reinforcement member of the side sill of the vehicle with the reinforcement member according to embodiments of the present disclosure is joined to a lateral side of the vehicle.

FIG. 6 is a cross-sectional view taken along line I-I of FIG. 5.

FIG. 7 is a cross-sectional view taken along line II-II of FIG. 5.

FIG. 8 is a cross-sectional view illustrating the side sill to which the reinforcement member according to embodiments of the present disclosure is applied.

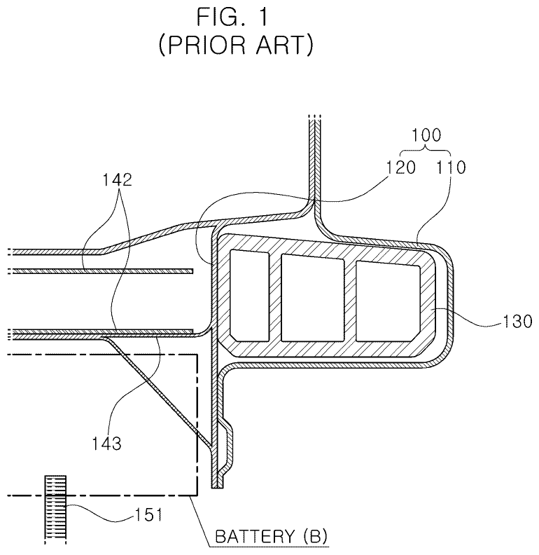

### DETAILED DESCRIPTION OF ILLUSTRATIVE EMBODIMENTS

Hereinafter, a side sill of a vehicle with a reinforcement member according to embodiments of the present disclosure will be described in detail with reference to the accompanying drawings.

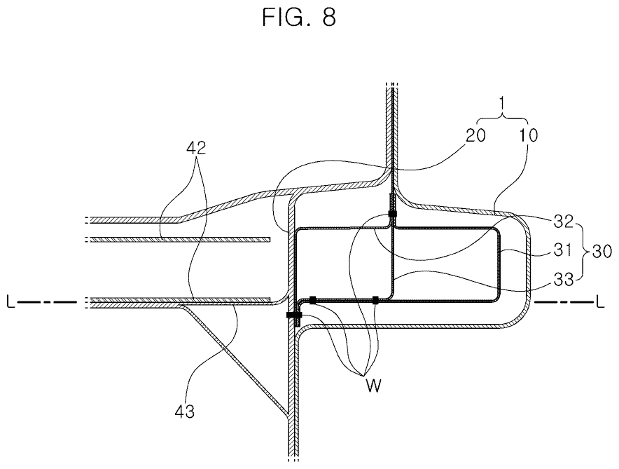

A side sill 1 of a vehicle with a reinforcement member according to embodiments of the present disclosure, as described in FIG. 8, may include a side sill outer 10 having a convex cross section toward an outside of a vehicle, a side sill inner 20 having a convex cross section toward an inside of the vehicle and coupled to an inside of the side sill outer 10, and a reinforcement member 30 installed between the side sill outer 10 and the side sill inner 20.

The side sill inner 20 may be coupled to the inside of the side sill outer 10, and the side sill 1 may become a lateral lower structural body of the vehicle with a hollow structure formed between the side sill outer 10 and the side sill inner 20.

The side sill inner 20 may be adjacent to a side end portion of a seat cross member 42 disposed in an interior of the vehicle in a widthwise direction of the vehicle, and a bottom surface of the seat cross member 42 and the side sill inner 20 may be connected by a center floor 43 so that the seat cross member 42 and the side sill inner 20 may be connected.

The side sill outer 10 may be joined to a lower portion of a center pillar of the vehicle.

The reinforcement member 30 may include a plurality of thin plates which is made of the same material as the side sill 1 to be joined by welding. The plurality of thin plates is joined to each other to form a closed cross section therebetween and may be installed in a space formed by the side sill outer 10 and the side sill inner 20 to improve rigidity of the side sill 1.

A cross section of the reinforcement member 30 may be formed in the shape of a closed cross section, and the reinforcement member 30 may be formed in the lengthwise direction of the vehicle. Since the reinforcement member 30 is installed inside the space formed by the side sill outer 10 and the side sill inner 20, the reinforcement member 30 may additionally support a collision load in the event of a side collision, thereby improving the rigidity of the side sill 1.

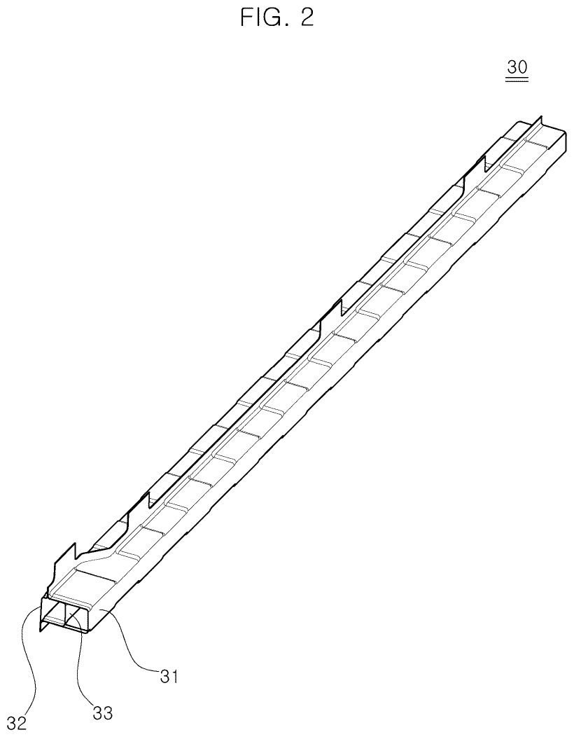

Referring to FIGS. 2-4, the cross section of the reinforcement member 30 may be formed to have a shape of a closed cross section. The reinforcement member 30 may include an outer member 31, an inner member 32, and a center member 33, which are machined from metal plates, and the outer member 31, the inner member 32, and the center member 33 may be joined to form the closed cross section in a lengthwise direction of the vehicle.

The outer member 31 may be formed to have a cross section that is convex to the outside of the vehicle, and the inner member 32 may be disposed inside of the vehicle from the outer member 31 and form a closed cross section with the outer member 31. The center member 33 may be disposed between the outer member 31 and the inner member 32 and may divide the closed cross section formed by the outer member 31 and the inner member 32. Thus, since the reinforcement member 30 has a plurality of closed cross sections, the rigidity of the side sill 1 may be increased.

In particular, a plurality of step portions 31c, 31f, 32c, 33c, and 33f which varies a height of a surface in the lengthwise direction of the vehicle may be formed on respective surfaces of the outer member 31, the inner member 32, and the center member 33, which are parallel to the ground. The plurality of step portions 31c, 31f, 32c, 33c, and 33f may be formed in the lengthwise direction of the vehicle to alternately decrease or increase heights of the surfaces parallel to the ground so that rigidities of the outer member 31, the inner member 32, and the center member 33 may be improved, respectively.

A detailed description of the outer member 31, the inner member 32, and the center member 33 will be made as follows.

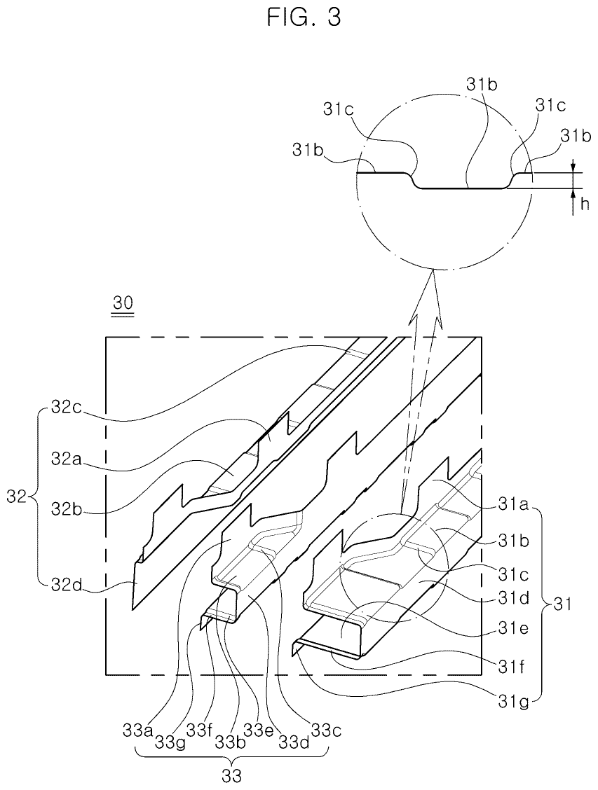

The outer member 31, as shown in FIG. 3, may include an upper bonding portion 31a perpendicular to the ground, an upper surface 31b extending from a lower end portion of the upper bonding portion 31a to the outside of the vehicle, a vertical surface 31d extending downward from an outer end portion of the upper surface 31b, a lower surface 31e extending from a lower end portion of the vertical surface 31d to the inside of the vehicle, and a lower bonding portion 31g extending downward from an inner end portion of the lower surface 31e. The outer member 31 may be formed in a cross-sectional structure similar to a “U” shaped member that is rotated by 90 degrees in a counterclockwise direction by the upper surface 31b, the vertical surface 31d, and the lower surface 31e.

In the outer member 31, the upper step portion 31c and the lower step portion 31f may be formed on the upper surface 31b and the lower surface 31e, respectively. Since the upper surface 31b and the lower surface 31e are substantially parallel to the ground in the outer member 31, the upper step portion 31c and the lower step portion 31f may be formed on the upper surface 31b and the lower surface 31e. The upper step portion 31c may be formed in the widthwise direction of the vehicle and may be repeatedly formed in the lengthwise direction of the vehicle. Thus, the upper step portion 31c may alternately raise or lower a height “h” of the upper surface 31b in the lengthwise direction of the vehicle. For example, the height of the upper surface 31b may be lowered by the upper step portion 31c, and then the height may be raised by the upper step portion 31c, and thus a bent cross-sectional structure may be repeated through repetition of the above-described way so that rigidity of the upper surface 31b may be improved. In the same manner, the lower step portion 31f may alternately raise or lower the height of the lower surface 31e in the lengthwise direction of the vehicle to improve rigidity of the lower surface 31e.

The inner member 32 may include an upper bonding portion 32a perpendicular to the ground, a horizontal surface 32b extending from a lower end portion of the upper bonding portion 32a to the inside of the vehicle, and a lower bonding portion 32d extending downward from an end portion of the horizontal surface 32b. The inner member 32 may have a cross-sectional shape similar to an “L” shaped member that is rotated by 18o degrees by the horizontal surface 32b and the lower bonding portion 32d.

Since the horizontal surface 32b is parallel to the ground in the inner member 32, the step portion 32c may be formed on the horizontal surface 32b. In the inner member 32, the step portion 32c may be formed on the horizontal surface 32b. Since the height of the horizontal surface 32b is repeatedly raised or lowered by the step portion 32c in the lengthwise direction of the vehicle, rigidity of the horizontal surface 32b may be improved.

The center member 33 may include an upper bonding portion 33a perpendicular to the ground, an upper surface 33b extending from a lower end portion of the upper bonding portion 33a to the outside of the vehicle, a vertical surface 33d extending downward from an outer end portion of the upper surface 33b, a lower surface 33e extending from a lower end portion of the vertical surface 33d to the inside of the vehicle, and a lower bonding portion 338 extending downward from an inner end portion of the lower surface 33e. The center member 33 may have a cross section similar to a “U” shaped member that is rotated by the upper surface 33b, the vertical surface 33d, and the lower surface 33e in some sections and may have a cross section similar to an “L” shaped member that is rotated in some sections.

Since the upper surface 33b and the lower surface 33e are parallel to the ground in the center member 33, the upper step portion 33c and the lower step portion 33f may be formed on the upper surface 33b and the lower surface 33e, respectively. Since heights of the upper surface 33b and the lower surface 33e in the center member 33 are alternately raised or lowered by the upper step portion 33c and the lower step portion 33f in the length direction of the vehicle, rigidity may be improved.

The outer member 31, the inner member 32, and the center member 33 may form an integrated structure of the reinforcement member 30 by the upper bonding portions 31a, 32a, and 33a and the lower bonding portions 31g, 32d, and 33g. The outer member 31, the inner member 32, and the center member 33 may form the reinforcement member 30 by joining the upper bonding portions 31a, 32a, and 33a and the lower bonding portions 31g, 32d, and 33g through welding, brazing, bonding or the like.

The reinforcement member 30 may be divided into the inside and the outside of the vehicle based on the vertical surface 33d of the center member 33 to form a first deformation section S1 and a second deformation section S2. In particular, as shown in FIG. 7, in a portion where the reinforcement member 30 is joined to the side sill inner 20, the first deformation section S1 and the second deformation section S2 may be formed based on the vertical surface 33d of the center member 33 so that the reinforcement member 30 may support the widthwise direction of the vehicle against a side collision load.

The lower bonding portions 31g, 32d, and 33g may be positioned further inside the vehicle than the upper bonding portions 31a, 32a, and 33a.

The outer member 31, the inner member 32, and the center member 33 may be manufactured by a cold stamping process with steel plates.

In addition, the outer member 31 may be formed as a thickest member and the center member 33 may be formed as a thinnest member among the outer member 31, the inner member 32, and the center member 33. For example, the outer member 31 may be formed to have a thickness of 1.4 mm, the inner member 32 may be formed to have a thickness of 1.2 mm, and the center member 33 may be formed to have a thickness of 1.0 mm.

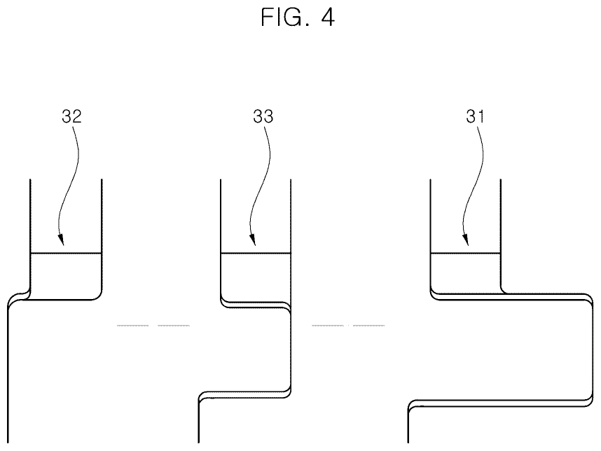

As shown in FIG. 4, the outer member 31, the inner member 32, and the center member 33 may be assembled in the widthwise direction of the vehicle, and then the upper bonding portions 31a, 32a, and 33a and the lower bonding portions 31g, 32d, and 33g may be joined by welding to form the reinforcement member 30.

Meanwhile, it is preferable that the outer member 31 and the center member 33 are joined by welding in a state in which the lower surface 33e of the center member 33 overlaps the lower surface 31e of the outer member 31.

When the reinforcement member 30 is completed by joining the outer member 31, the inner member 32, and the center member 33 to each other, the reinforcement member 30 may be assembled to the lower portion of the lateral side of the vehicle.

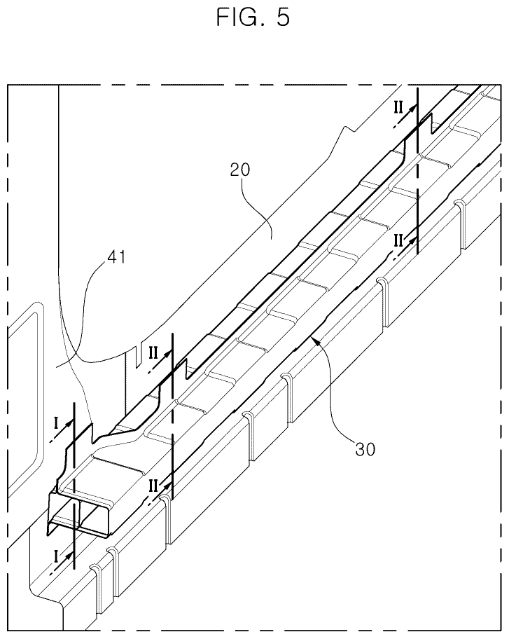

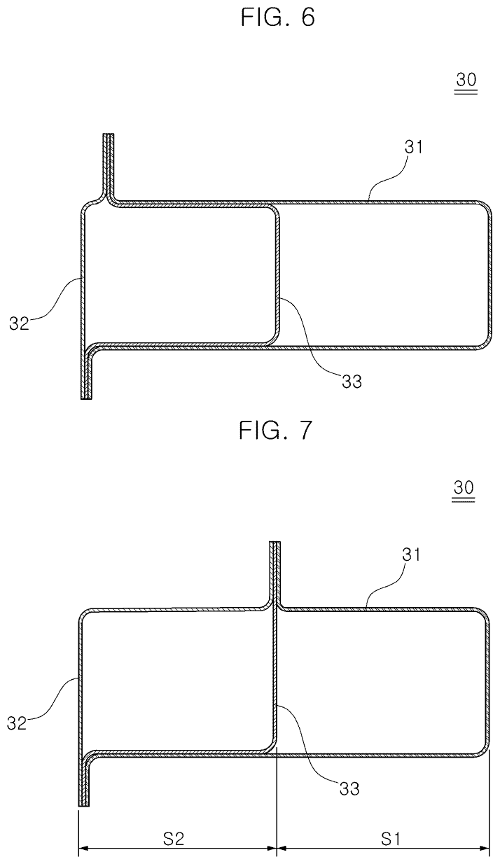

As shown in FIG. 5, the reinforcement member 30 may be joined to the lower portion of the lateral side of the vehicle. For example, the reinforcement member 30 may be joined to an outer side of the assembly of a front pillar inner lower 41 and the side sill inner 20. A front side of the reinforcement member 30, that is, within a predetermined length from a front end portion of the reinforcement member 30, may be joined to the front pillar inner lower 41, and a portion excluding the front side of the reinforcement member 30, that is, beyond the predetermined length from the front end portion of the reinforcement member 30, may be joined to the side sill inner 20. The reinforcement member 30 may be joined to the front pillar inner lower 41 and the side sill inner 20 using the upper bonding portions 31a, 32a, and 33a and the lower bonding portions 31g, 32d, and 33g.

Meanwhile, since the front pillar inner lower 41 is positioned further inside the vehicle than the side sill inner 20, the upper bonding portions 31a, 32a, and 33a may be positioned inside the vehicle within the predetermined length from the front end portion of the reinforcement member 30 rather than beyond the predetermined length.

Thus, the upper surface 33b of the center member 33 may be formed within a predetermined length from the front end portion of the reinforcement member 30, and beyond the predetermined length, the upper bonding portion 33a of the center member 33 may be directly connected to the vertical surface 33d of the center member 33.

Thereafter, the side sill outer 10 may be joined to an outer side of the reinforcement member 30.

FIG. 8 shows a cross section of the lower portion of the lateral side of the vehicle. A lower end portion of the reinforcement member 30, that is, a lower end portion of the outer member 31, may be positioned at the same height as a lower end portion of the seat cross member 42. In FIG. 8, it may be noted that the lower end portion of the outer member 31 and the lower end portion of the seat cross member 42 may be positioned on line L-L and thus may be positioned at the same height. In this way, in the event of a side collision, a load path may be formed through which a collision load is transmitted toward the interior of the vehicle, thereby providing an efficient structure for absorbing the collision load.

In accordance with a side sill of a vehicle with a reinforcement member having the above-described configuration, since an outer member, an inner member, and a center member of the reinforcement member may be made of the same material as a side sill outer and a side sill inner, the reinforcement member may be joined by welding so that a manufacturing process may be simplified and a manufacturing time may be reduced.

In addition, since the outer member, the inner member, and the center member constituting the reinforcement member may be made of thin plates and joined to each other, a weight of the reinforcement member may be maintained at the same level as that of a reinforcement member with an extruded material so that a weight of a vehicle is not affected.

In addition, since a lower surface of the outer member coincides with a lower end portion of a seat cross member and step portions may be formed in the outer member, the inner member, and the center member in a widthwise direction of the vehicle, a collision load input in the event of a side collision may be supported so that the side sill may be prevented from intruding into an interior of the vehicle in the event of the side collision.

While the present disclosure has been described with reference to the accompanying drawings, it will be apparent to those skilled in the art that various changes and modifications may be made without departing from the spirit and scope of the present disclosure without being limited to the exemplary embodiments disclosed herein. Accordingly, it should be noted that such alternations or modifications fall within the claims of the present disclosure, and the scope of the present disclosure should be construed on the basis of the appended claims.

What is claimed is:

1. A side sill of a vehicle, the side sill comprising:
a side sill outer having a first convex cross section toward an outside of the vehicle;
a side sill inner coupled to an inside of the side sill outer and having a second convex cross section toward an inside of the vehicle; and
a reinforcement member disposed in a space between the side sill outer and the side sill inner, the reinforcement member comprising a plurality of thin plates made of a same material as the side sill and joinable to the side sill by welding, the thin plates being joined to each other to define a closed cross section therebetween and disposed in the space.

2. The side sill of claim 1, wherein the thin plates comprise:
an outer member having a third convex cross section toward the outside of the vehicle;
an inner member disposed inside the vehicle in the outer member and defining a second closed cross section with the outer member; and
a center member disposed between the outer member and the inner member and dividing the closed cross section defined by the outer member and the inner member, wherein the outer member, the inner member, and the center member are joined to define the closed cross section in a lengthwise direction of the vehicle.

3. The side sill of claim 2, further comprising a plurality of step portions disposed on surfaces of the outer member, the inner member, and the center member that are parallel to the ground, the step portions varying heights of the surfaces in the lengthwise direction of the vehicle.

4. The side sill of claim 3, wherein the step portions are repeatedly disposed on the surfaces at intervals in the lengthwise direction of the vehicle.

5. The side sill of claim 4, wherein the step portions are disposed to alternately lower or raise the heights of the surfaces parallel to the ground.

6. The side sill of claim 2, wherein a first thickness of the outer member is greater than a second thickness of the inner member, and wherein the second thickness of the inner member is greater than a third thickness of the center member.

7. A side sill of a vehicle, the side sill comprising:
a side sill outer having a first convex cross section toward an outside of the vehicle;
a side sill inner coupled to an inside of the side sill outer and having a second convex cross section toward an inside of the vehicle; and
a reinforcement member disposed in a space between the side sill outer and the side sill inner, the reinforcement member comprising a plurality of thin plates made of a same material as the side sill and joinable to the side sill by welding, the thin plates being joined to each other to define a closed cross section therebetween and disposed in the space, and the thin plates comprising:
an outer member having a third convex cross section toward the outside of the vehicle, the outer member comprising:
an upper surface extending to the outside of the vehicle;
a vertical surface extending downward from an outer end portion of the upper surface;
a lower surface extending from a lower end portion of the vertical surface to an inside of the vehicle; and
upper step portions and lower step portions having varying heights, the upper step portions and the lower step portions being repeatedly disposed at intervals on the upper surface and the lower surface, respectively, in a length direction of the vehicle;
an inner member disposed inside the vehicle in the outer member and defining a second closed cross section with the outer member; and
a center member disposed between the outer member and the inner member and dividing the closed cross section defined by the outer member and the inner member, wherein the outer member, the inner member, and the center member are joined to define the closed cross section in the length direction of the vehicle.

8. The side sill of claim 7, wherein:
the inner member comprises a horizontal surface extending inside the vehicle; and
step portions having varying heights are disposed on the horizontal surface.

9. The side sill of claim 8, wherein the center member comprises:
a second upper surface extending to the outside of the vehicle;
a second vertical surface extending downward from an outer end portion of the second upper surface;
a second lower surface extending from a lower end portion of the second vertical surface to the inside of the vehicle and overlapping the lower surface of the outer member to be joined thereto; and
second upper step portions and second lower step portions having varying heights, the second upper step portions and the second lower step portions being disposed at intervals on the second upper surface and the second lower surface, respectively, in the length direction of the vehicle.

10. The side sill of claim 9, wherein:
upper bonding portions and lower bonding portions are disposed at upper ends and lower ends of the outer member, the inner member, and the center member; and
the upper bonding portions and the lower bonding portions are joined so that the outer member, the inner member, and the center member are integrated.

11. The side sill of claim 10, wherein the lower bonding portions are disposed further inside the vehicle than the upper bonding portions.

12. The side sill of claim 10, wherein the upper bonding portions and the lower bonding portions are joined to a front pillar inner lower of the vehicle within a predetermined length from a front end portion of the reinforcement member.

13. The side sill of claim 12, wherein the second upper surface of the center member is disposed within the predetermined length from the front end portion of the reinforcement member.

14. The side sill of claim 12, wherein the upper bonding portion of the center member is directly connected to the second vertical surface of the center member beyond the predetermined length from the front end portion of the reinforcement member in the center member.

15. The side sill of claim 10, wherein the upper bonding portions and the lower bonding portions are joined to the side sill inner beyond a predetermined length from a front end portion of the reinforcement member.

16. The side sill of claim 10, wherein, in the outer member, the upper bonding portion extends upward from an inner end portion of the upper surface and the lower bonding portion extends downward from an inner end portion of the lower surface.

17. The side sill of claim 10, wherein, in the inner member, the upper bonding portion extends upward from an outer end portion of a third horizontal surface and the lower bonding portion extends downward from an inner end portion of the third horizontal surface.

18. The side sill of claim 10, wherein, in the center member, the upper bonding portion extends upward from an inner end portion of the second upper surface and the lower bonding portion extends downward from an inner end portion of the second lower surface.

19. The side sill of claim 7, wherein the lower surface of the outer member is disposed at a same height as a lower end portion of a seat cross member whose side end is positioned inside the side sill inner in the vehicle.

20. A method of providing a side sill of a vehicle, the method comprising:
providing a side sill outer having a first convex cross section toward an outside of the vehicle;
providing a side sill inner coupled to an inside of the side sill outer and having a second convex cross section toward an inside of the vehicle; and
disposing a reinforcement member in a space between the side sill outer and the side sill inner, the reinforcement member comprising a plurality of thin plates made of a same material as the side sill and joinable to the side sill by welding, the thin plates being joined to each other to define a closed cross section therebetween and disposed in the space, wherein the thin plates comprise:
an outer member having a third convex cross section toward the outside of the vehicle;
an inner member disposed inside the vehicle in the outer member and defining a second closed cross section with the outer member; and
a center member disposed between the outer member and the inner member and dividing the closed cross section defined by the outer member and the inner member, wherein the outer member, the inner member, and the center member are joined to define the closed cross section in a lengthwise direction of the vehicle, and wherein the outer member, the inner member, and the center member are manufactured by a cold stamping process with steel plates.
